(19) United States
(12) Patent Application Publication
(10) Pub. No.: US 2016/0167875 A1
(43) Pub. Date: Jun. 16, 2016

(54) REFUSE SCANNER

(71) Applicant: Joshua F. Young, Santa Ana, CA (US)

(72) Inventor: Joshua F. Young, Santa Ana, CA (US)

(21) Appl. No.: 14/966,904

(22) Filed: Dec. 11, 2015

Related U.S. Application Data
(60) Provisional application No. 62/091,401, filed on Dec. 12, 2014.

(51) Int. Cl. B65F 1/14; G06K 7/10; B65F 1/16

(52) U.S. Cl. CPC B65F 1/1484; B65F 1/16; G06K 7/10138

(57) ABSTRACT

Described herein are refuse containers that include a scanning device that can be configured to send data to a remote computing device. Methods of using these refuse containers are also described.

### CROSS REFERENCE TO RELATED APPLICATION

This application claims the benefit of U.S. Provisional Patent Application No. 62/091,401, filed Dec. 12, 2014, the entire disclosure of which is incorporated herein by reference.

### FIELD

Described herein are refuse containers that include a scanning device that can be configured to send data to a remote computing device. Methods of using these refuse containers are also described.

### SUMMARY

Generally described herein are refuse scanners, scanning devices, refuse scanning systems, and methods of using the same.

In one embodiment, refuse scanners are described comprising: a refuse container; a scanning device configured to scan refuse added to the refuse container; and at least one identification label configured to be read by the scanning device. In another embodiment, the scanning device is an RFID scanner.

The scanning device can be configured to transmit data to a remote computing device such as a cloud based computing system. The scanning device can be configured to transmit the data to the remote computing device without processing the data. The remote computing device can process the data acquired from the scanning device and automatically re-order a specific item being scanned, alert a user that the specific item is needed, automatically add the specific item to an electronic shopping cart, or a combination thereof.

The scanning device can further include a network interface device configured to connect the scanning device to a remote computing device.

In some embodiments, the refuse container can include a lid that is configured to power on the scanner when opened and/or power off the scanner when closed.

Further, the at least one identification label can be attached to a specific product to identify the product to the scanning device. The specific product can be, for example, a grocery item.

Methods of scanning refuse are also described. These methods can include scanning refuse entering a refuse container using a scanning device associated with the refuse container to identify at least one specific product, wherein the scanning device is configured to transmit data to a remote computing device. The remote computing device can process the data acquired from the scanning device and automatically re-order a specific item being scanned, alert a user that the specific item is needed, automatically add the specific item to an electronic shopping cart, or a combination thereof.

In some embodiments, the methods can further include attaching at least one identification label to the specific product. Also, the methods can include identifying the specific product based on the at least one identification label.

The methods can further include opening a lid on the refuse container to power on the scanning device and/or closing the lid on the refuse container to power off the scanning device. In some embodiments, when the lid is closed, the scanning device may stay powered on for a period of time thereafter. For example, the scanning device may stay powered on after the lid has been closed for about 10 seconds, about 30 seconds, about 1 minute, about 5 minutes, about 10 minutes, between about 10 seconds and about 10 minutes, or between about 30 seconds and about 5 minutes.

Refuse scanners are also described including: a refuse container including an RFID scanner attached to the refuse container; at least one identification label attached to a refuse item and configured to be read by the RFID scanner; and a cloud based computing system configured to receive raw data from the RFID scanner. In some embodiments, the RFID scanner can be mounted on the inside of the lid.

### BRIEF DESCRIPTION OF THE DRAWINGS

FIG. 1 illustrates an embodiment of a refuse device as described herein.

FIG. 2 illustrates an embodiment of the refuse device of FIG. 1 in use.

FIG. 3 illustrates another embodiment of a refuse device as described herein.

FIG. 4 illustrates an embodiment of the refuse device of FIG. 3 in use.

### DETAILED DESCRIPTION

Described herein generally are refuse devices and methods of using the same. The refuse devices can be in the form of containers configured to scan refuse placed in or added to the containers. Refuse as used herein can be used to describe garbage, waste, recyclable waste, trash, paper/documents, and the like.

Numerous online grocery and other good supplier startups have started and subsequently failed altogether or only met with limited success. Many factors can be contributed to a lack of user uptake on these cloud platforms. Aside from qualitative reasons, like picking one's own produce, and the like, other reasons can include, but are not limited to timely delivery, ordering convenience, and/or customer retention. Customer retention can be defined as the likelihood that a customer re-uses a service.

In today's marketplace, timely delivery of goods has been largely addressed. Many online grocery establishments now deliver on the same day or next day for many of the items in inventory. This development has stimulated resurgence in online grocery shopping and similar initiatives are being pushed forward by other suppliers as well. For example, some services offer personal shoppers and the like to bring goods to the home as quickly as possible.

Regarding ordering convenience and customer retention, shopping favorites lists, automatic reordering, subscription based food/goods delivery, and the like have been investigated. However, these processes can be difficult, non-intuitive, and heavy on end user interaction.

There have been marketplace attempts to automate and simplify the order process on the user/consumer/end user arena, but generally they are incomplete, require too much user intervention (personal inventory systems), extensive image recognition logic (smart refrigerators), and the like. For example, attempting to canvas an area with sensors required to acquire data can be expensive and difficult. Present systems attempt to canvas the entire kitchen, placing sensors in the pantry, refrigerator, and other storage areas. Most of these types of solutions force behavior changes on prospective shoppers, something that online grocers and goods distributors attempt to avoid because it can negatively impact customer retention.

Thus, the devices, system and methods described herein present a solution able to capture all sorts of non-durable goods that require frequent reorders in a single system and make ordering painless, intuitive, and require minimal changes to consumer behavior.

The devices and systems described herein can be located in a place, for example in the kitchen, that many, if not substantially all, disposable goods end up. Disposable goods often times end up in a trash or refuse container.

As described herein, in some embodiments, RFID tags/labels can be used as a method to determine what is being added to the trash can. Thus, suppliers can attach RFID labels as described herein to goods in its supply chain and a scanner as described herein can reliably identify all goods disposed of.

In some embodiments, the refuse container can be formed of metal to assist in the functionality of an RFID scanner. A metal refuse container can prevent the RFID scanner's signal from receiving false reads from other local environmental interferences.

Often times, RFID scanners can be expensive. In some instances, RFID scanners can cost upwards of $700-$2,000. Thus, adding an expensive RFID scanner or other reader to a household refuse container may not be practical and may not be something consumers are willing to spend money on. Further, companies placing goods in the stream of commerce may not be willing to invest in subsidizing the cost of placing a scanner in every consumer's home simply for purposes of easy order management.

In contrast to expensive RFID scanner solutions, the system and devices described herein provide a scanner that is connected to a cloud based or remote computing system that can reduce the RFID scanner hardware costs. The remote computing system can be an integral part of the present systems. The remote computing system can reduce cost by receiving or uploading data immediately and doing much of, if not all, processing of scanned data in a cloud or remote computing environment, rather than locally. This movement of processing to a remote computing system can reduce costs associated with the RFID scanner, in some cases substantially.

Once the data is in the “cloud,” the consumer can then be presented with an automated ordering process that intelligently orders groceries and other goods through a combination of RFID scans, automatically expired products, suggestions based on ratings/recommendations, meal preferences, ethnic preferences, dietary restrictions, and the like.

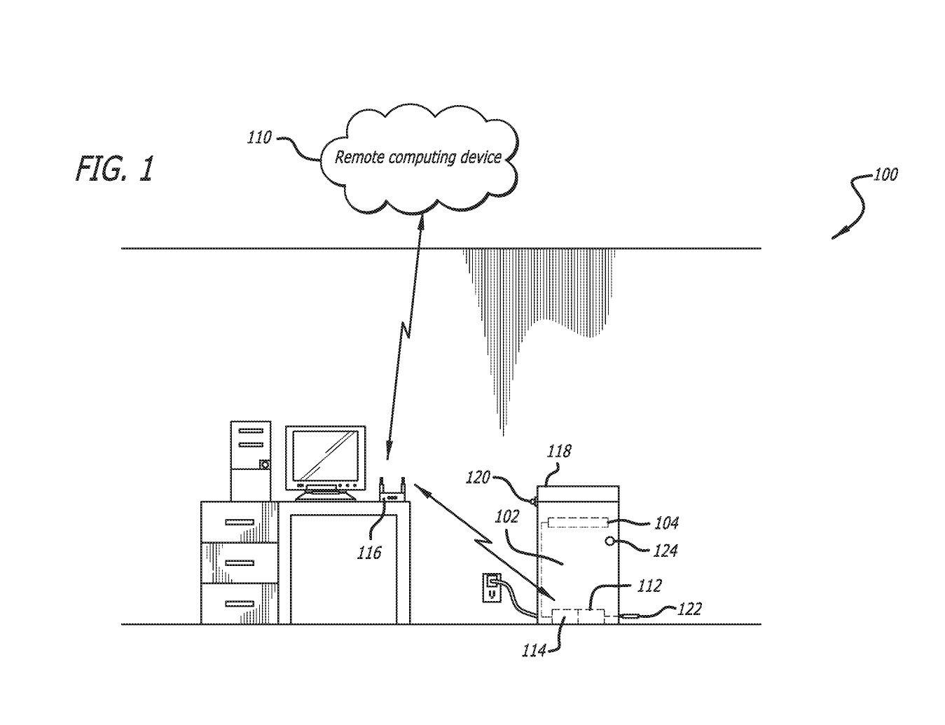

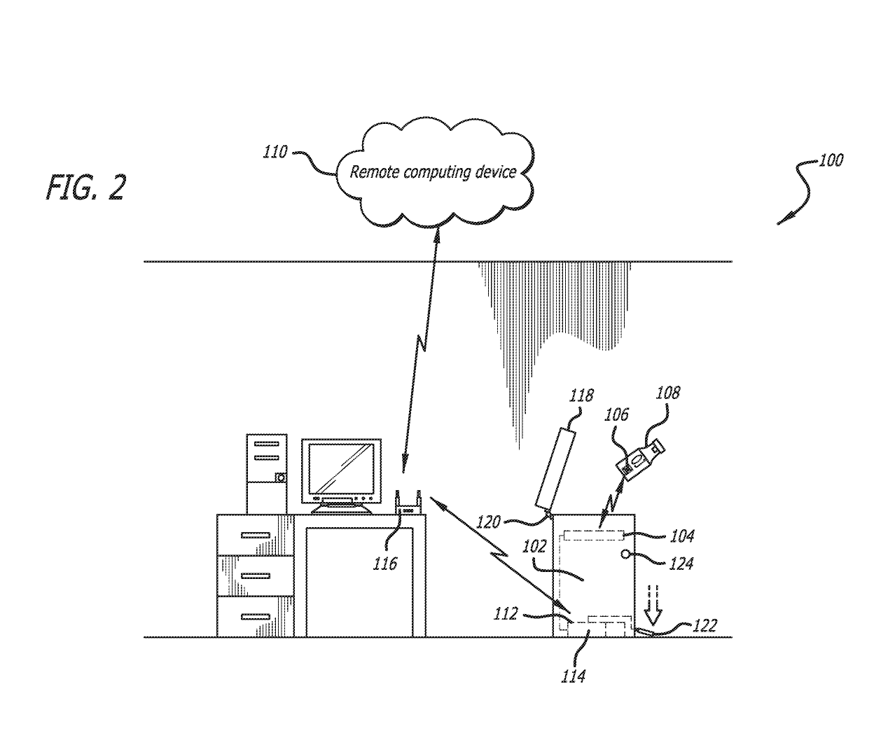

An example embodiment of a refuse device 100 including a refuse container or simply container 102 is illustrated in FIG. 1 and FIG. 2.

Refuse devices can include one or more scanners or scanning devices 104 used to scan refuse being added to the refuse container. In one embodiment, scanning device 104 can be an RFID scanner. This scanner(s) can be associated with the refuse container in a configuration to scan items added to refuse container 102.

A refuse container 102 can be a trash can, recycle bin, a landfill, a trash compactor, a receptacle, a trash incinerator, a trash truck, a toilet, a septic tank, a sewer pipe, an electronic waste container, a battery disposal container, a battery recycle container, a hazardous chemical container, a biohazard container, or an animal refuse container. Refuse container 102 can be formed of a polymer such as a plastic or can be formed of a metal such as stainless steel or aluminum. In one embodiment, refuse container 102 can be formed of a metal to prevent external interference with scanning device 104 and/or prevent false reads. External interference can come in the form of wireless signals from other devices, magnetic fields, microwaves, and the like. False reads can potentially be from RFID tags that are not in the refuse container but rather in an adjacent location that might be accidentally read by the RFID scanner.

Refuse container 102 can have virtually any volumetric shape. For example, refuse container 102 can have a circular, square, rectangular, trapezoidal, elliptical, or other rectilinear cross-sectional shape. In one embodiment, the volumetric shape of refuse container 102 can be configured to optimize scanning of refuse.

The scanning device associated with the refuse container can be configured to scan a tag or label associated with an item being disposed of or otherwise added to the refuse container. The scanning device can include multiple scanners or can include a single scanner. In one embodiment, a scanning device can be a ring of scanners that line the rim of a refuse container. In other embodiments, multiple single scanning devices can be placed along the rim of the refuse container. For example, two, three, four, five or more scanners can line the rim of the refuse container.

In still another embodiment, the scanning device can be located on the inside surface of a lid associated with the refuse container. When located on the inside of the lid, a scan can be preformed when the lid is opened or can be performed when the lid is closed thereby preventing false reads.

The scanning device can also include a single antenna or multiple antennas configured to scan a larger area and/or improve the scan results. In one embodiment, multiple antennas can be placed along the inside surface of the refuse container. For example, two, three, four, five or more antennas can be included on the inside of the refuse container in order to scan a larger area and/or improve the scan results.

In one embodiment, a tag 106 or multiple tags can be added to a product 108 by the manufacturer, the distributor, or any other party in the stream of commerce. In other embodiments, tag(s) 106 can be added by the consumer to track disposal of household items.

Tag 106 can be an identification label which can be an RFID tag in some embodiments.

The identification label can be configured to be read by the scanning device or the scanning device can be configured to read the identification label. In some embodiments, at least one identification label is attached to a specific product to identify the product to the scanning device 104.

In some embodiments, scanning device 104 can be configured to transmit data to a remote computing device 110. This data can be in the form of transformed data or raw data. Transformed data can be information about the labeled product such as, but not limited to, tag number, item skew, item expiration date, item brand, item quantity or volume, item age, and the like.

In one embodiment, to reduce the workload of a scanning device, only a tag number is read off the identification label. In such an embodiment, further processing of the tag number, such as determining what the product is, its skew, expiration date, brand, quantity or volume, age, and the like, can be performed by a remote computing device. Further, the remote computing device can process re-orders of the disposed items.

In other embodiments, the data can be raw data transmitted to remote computing device 110. In some embodiments, scanning device 104 does not process the data and sends the raw data from a scan(s) to remote computing device 110. In such an embodiment, the hardware for scanning device 104 can be minimal and require minimal power to function. Such a scanning device with minimal hardware requirements can be less expansive than other scanning devices that can process information from a scan prior to transmitting it to a remote computing device.

In some embodiments, in order to transmit data to remote computing device 110, the refuse devices described herein include a network interface 112. This network interface can be a standalone device, can be within, on or associated with the scanning device, or can be within, on or associated with an optional controller 114. If present, controller 114 can include a processor and executable instructions for running the scanning device and the network interface 112. In some embodiments, to reduce costs associated with the devices described herein, controller 114 can have minimal processing power and can run open source software. For example, controller 114 can be an open source or development device such as a Raspberry Pi. In one embodiment, optional controller 114 and scanning device 104 can be located at the same location and/or the scanning device 104 can be built onto/into controller 114.

This network interface 112 can be wired or wireless. Wired network configurations can be through universal serial bus (USB), firewire, Thunderbolt, 10/100 Ethernet, 10/100/1,000 Ethernet, 10/100/1,000/10,000 Ethernet, fiber optic wire, coaxial wire, media over coaxial wire (MoCA), and the like. Faster and newer network technologies can be used with the devices described herein.

Likewise, wireless network configurations can also be used. Wireless network can be provided by WiFi and equivalents thereof, cellular networks such as 3G, LTE, and the like, and direct satellite communication.

The network configuration in FIG. 1 and FIG. 2 is a wireless communication between network interface 112 and wireless router 116. Although shown as a common household wireless network connection, a wired connection or a cellular connection is also possible.

The network connection can allow refuse devices to transmit data to the remote computing device. Remote computing device 110 can be in the form of a processor driven computing device. Such devices can include, but are not limited to cellular phones, smart phones, tablet, laptops, desktop computers, servers, NAS servers, and cloud based computing systems.

In one embodiment, remote computing device 110 can be a cloud based computing system.

Remote computing device 110 can process data it receives thereby alleviating the need for the refuse device and/or scanner to perform some or any processing of the data acquired by scanning device 104. In some embodiments, the scanning device is configured to transmit the data to the remote computing device without processing the data.

In one embodiment, refuse container 102 can include a lid 118. Lid 118 can be configured to power on the scanner when opened. Likewise, lid 118 can be configured to power off the scanner when closed. Lid 118 can be attached to refuse container 102 via a hinge 120. In some embodiments, when lid 118 is closed, scanning device 104 may stay powered on for a period of time thereafter. For example, scanning device 104 may stay powered on after lid 118 has been closed for about 10 seconds, about 30 seconds, about 1 minutes, about 5 minutes, about 10 minutes, between about 10 seconds and about 10 minutes, or between about 30 seconds and about 5 minutes.

In other embodiments, scanning device 104 can be programmed to be woken up at periodic predetermined times and/or for predetermined times.

However, in other embodiments, a lid may not need to include a hinge and can be fully removable from refuse container 102. If no lid is included with refuse container 102, then scanning device 104 may remain powered on all the time or may have a sleep/hibernation mode to save power.

Further, refuse container 102 can include a foot pedal 122 that can be used/configured to open lid 118.

Refuse container can include an indicator 124 that displays the status of scanning device 104. Indicator 124 can be an LED light or other lighting device that can indicate the status of scanning device 104. For example, in one embodiment, a first LED color, for example green, can be illuminated when scanning device 104 is powered on and a second LED color, for example red, can be illuminated when scanning device 104 is powered off. Further, a third LED color, for example yellow, can be illuminated when scanning device 104 is actually scanning. Further still, a fourth LED color, for example blue, can be illuminated when scanning device 104 is transferring data to the remote computing device 110. Other colors can be added for other functions. Likewise, multiple LEDs can be used instead of alternating colors. Such an indicator can allow a user to know when scanning device 104 is powered on and ready to scan, thereby providing more accurate scanning of refuse added to refuse container 102.

Power to controller 114 and/or scanning device 104 can be provided by a power source. A power source can include a wall plug. Wall plugs can be provided with different voltage for different power grids in different countries. Likewise, controller 114 and/or scanning device 104 can be powered by a battery.

Refuse container 102 can be configured to accept standard sized batteries to power controller 114 and/or scanning device 104. Standard size batteries can include, but are not limited to round, cylindrical batteries such as AA, AAA, AAAA, C, D, and button cell (such as lithium button), coin cell, and non-round batteries such as 4.5V box and 9V box batteries, and the like. Further button cell or coin cell batteries can be used. Batteries can be removed as needed to clean and/or sterilize refuse container 102 as needed. In some embodiments, the battery or batteries can be rechargeable.

In some embodiments, a refuse device need not include a refuse container. Rather, a refuse scanning device can be supplied as a retrofit item for an existing refuse container. Such a retrofit device can be battery powered or require a wall plug. For example, such a device can come equipped with a latch or clip that is configured to attach the scanner to the rim or side wall of a refuse container.

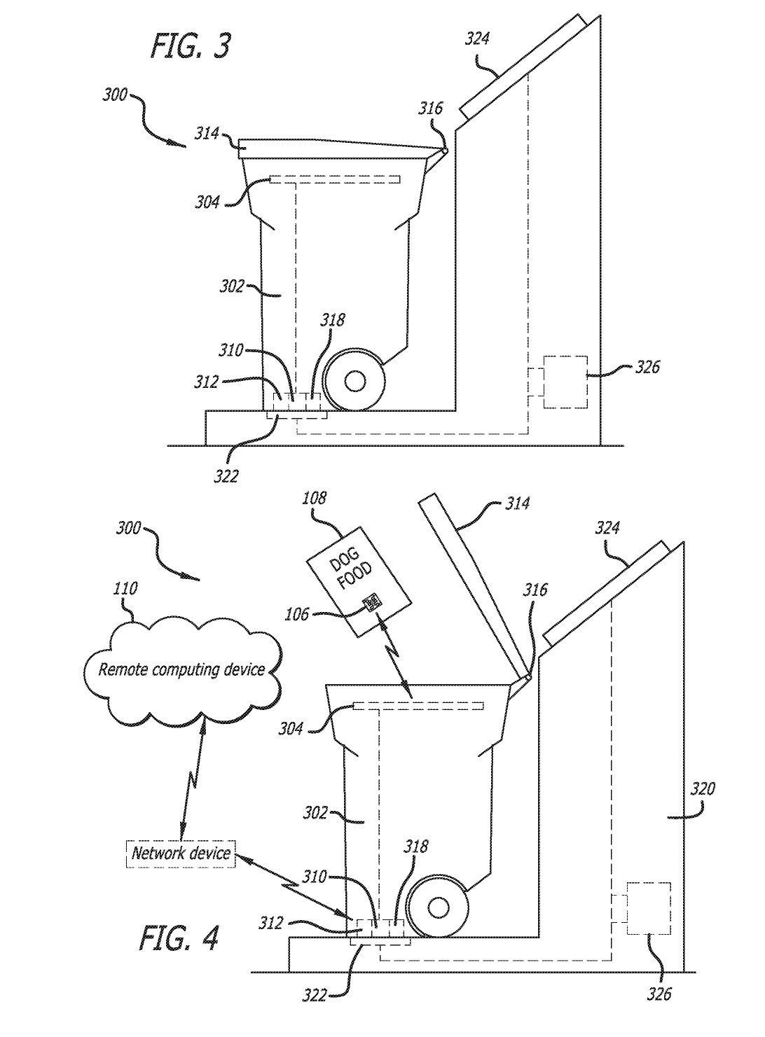

In another example embodiment, refuse device 300 is illustrated in FIG. 3 and FIG. 4. Refuse device 300 includes a refuse container 302. Here, refuse container 302 is in the form of a municipal trash can or recycle bin. The bin can be formed of plastic, metal, or a combination thereof. Such a bin can be wheeled for convenience.

One or more scanners or scanning devices 304 can be included and used to scan refuse being added to the refuse container. In one embodiment, scanning device 304 can be an RFID scanner. This scanner(s) can be associated with the refuse container in a configuration to scan items added to refuse container 302.

In one embodiment, as described, a tag 106 or multiple tags can be added to a product 108. Additionally, here multiple tags can be scanned at one time because they may be included in a larger trash bag collected at another location. Note, that all devices described herein can function in this way. Thus, a scanner can possess the ability to scan multiple items at once.

In some embodiments, as described, scanning device 304 can be configured to transmit data to a remote computing device 110.

Refuse device 300 can include a network interface 310 within a controller 312. In one embodiment, controller 312 and scanning device 304 can be located at the same location and/or the scanning device 304 can be built onto/into controller 312.

Here, generally, refuse container 302 can be located outside the house. Thus, a wireless network connection can be desired although a wired connection can still be used. Further, a cellular connection is also possible.

In one embodiment, refuse container 302 can include a lid 314. Lid 314 can be configured to power on scanning device 304 when opened. Likewise, lid 314 can be configured to power off scanning device 304 when closed. Lid 314 can be attached to refuse container 302 via a hinge 316. However, in other embodiments, a lid may not need to include a hinge and can be fully removable from refuse container 302. If no lid is included with refuse container 302, then scanning device 304 may remain powered on all the time or may have a sleep/hibernation mode to save power.

Power to controller 312 and/or scanning device 304 can be provided by a power source. A power source can include a battery 318 or batteries. In one embodiment, battery 318 can be rechargeable.

Battery 318 can be recharged at a charging station 320. Charging station 320 can include a connection 322 (e.g., induction plate) that can be used to charge battery 318. Refuse container 302 can include a complimentary structure to accept charge from connection 322.

Charging station 320 can also include a power source. Power can be provided by a hardwire connection to the local power grid. Also, power can be provided by a solar panel(s) 324. Solar panels can charge a battery 326 within charging station 320 which in turn can charge battery 318 when refuse container 302 is docked in the charging station.

In one embodiment, the product to be labeled and eventually scanned upon entry into the refuse container as described herein can be a grocery item or other good in the stream of commerce.

Common supply chains typically only tag/label carton or pallet level boxes because consumers do not possess scanners that can read tags/labels on individual items. However, with the scanning devices and cloud based systems described herein, it becomes cost effective for suppliers to tag/label individual goods, for example with an RFID tag.

Methods of scanning refuse are also described. Methods can include the step of scanning refuse entering a refuse container using a scanning device associated with the refuse container to identify at least one specific product. The product being scanned can be any grocery, durable, or nondurable good as described herein or envisioned. The scanner can be configured to transmit data to a remote computing device, such as a cloud server or cloud based computing system.

The remote computing device can be configured to process data acquired and sent from the scanning device. Once processed by the remote computing device, the specific item(s) that were scanned can be automatically re-ordered or placed in an electronic shopping cart to be reordered. The remote computing device can send electronic reminders, such as text messages or emails, that a specific item was discarded and/or that the specific item was placed in a basket, ordered, or with delivery information for the specific item.

The scanner can scan an identification label or tag associated with a product or good to be scanned. As such, a step in a method as described can be for a supplier or other entity in the chain of commerce to attach at least one identification label to the specific product(s). Once a good or product is labeled, the scanner and/or remote computing system can identify the specific product based on the at least one identification label.

In one embodiment, it is the remote computing device that identifies the product being added to the refuse container. In a further embodiment, the scanning device is configured to transmit the data to the remote computing device without processing the data.

In some embodiments, where the refuse container includes a foot pedal to open a lid, this foot pedal can be used to power on the scanner or wake the scanner from a sleep/hibernation state. Thus, with such a device, a step in a method of using the refuse container can be to open the lid to power on/wake the scanning device. Likewise, another step can be to close the lid on the refuse container to power off the scanning device. Further, as described, when the lid is closed, the scanning device may stay powered on and actively scan for a period of time after the lid has been closed.

In some embodiments, a second foot pedal can be included to manually activate the scanning device to perform a scan. With a second foot pedal, the first foot pedal can be used to open the refuse container to dispose of refuse and once the lid is closed, the second foot pedal can be depressed to start a scan.

The presently described devices and systems can also work in conjunction with other inventory systems to provide a customer with an integrated and/or all inclusive solution. For example, the present devices can integrate devices such as smart refrigerators to assess a grocery customer's needs and provide redundancy in inventory needs.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A refuse scanner comprising:
a refuse container;
a scanning device configured to scan refuse added to the refuse container; and
at least one identification label configured to be read by the scanning device.

2. The refuse scanner of claim 1, wherein the scanning device is configured to transmit data to a remote computing device to process the data acquired from the scanning device and automatically re-order a specific item being scanned, alert a user that the specific item is needed, automatically add the specific item to an electronic shopping cart, or a combination thereof.

3. The refuse scanner of claim 2, wherein the remote computing device is a cloud based computing system.

4. The refuse scanner of claim 2, wherein the scanning device is configured to transmit the data to the remote computing device without processing the data.

5. The refuse scanner of claim 1, further comprising a network interface device configured to connect the scanning device to a remote computing device.

6. The refuse scanner of claim 1, wherein the refuse container includes a lid that is configured to power on the scanner when opened.

7. The refuse scanner of claim 1, wherein the refuse container includes a lid that is configured to power off the scanner when closed.

8. The refuse scanner of claim 1, wherein the at least one identification label is attached to a specific product to identify the product to the scanning device.

9. The refuse scanner of claim 8, wherein the specific product is a grocery item.

10. The refuse scanner of claim 1, wherein the scanning device is an RFID scanner.

11. A method of scanning refuse, the method comprising:
scanning refuse entering a refuse container using a scanning device associated with the refuse container to identify at least one specific product,
wherein the scanning device is configured to transmit data to a remote computing device to process data acquired from the scanning device and automatically re-order a specific item being scanned, alert a user that the specific item is needed, automatically add the specific item to an electronic shopping cart, or a combination thereof.

12. The method of claim 11, further comprising attaching at least one identification label to the at least one specific product.

13. The method of claim 12, further comprising identifying the at least one specific product based on the at least one identification label.

14. The method of claim 11, wherein the remote computing device is a cloud based computing system.

15. The method of claim 11, wherein the scanning device is configured to transmit the data to the remote computing device without processing the data.

16. The method of claim 11, wherein the scanning device includes a network interface device configured to connect the scanning device to the remote computing device.

17. The method of claim 11, further comprising opening a lid on the refuse container to power on the scanning device.

18. The method of claim 11, further comprising closing a lid on the refuse container to power off the scanning device.

19. The method of claim 11, wherein the scanning device is an RFID scanner.

20. A refuse scanner comprising:
a refuse container including an RFID scanner attached to the refuse container;
at least one identification label attached to a refuse item and configured to be read by the RFID scanner; and
a cloud based computing system configured to receive raw data from the RFID scanner.
